(19) United States
(12) Patent Application Publication
(10) Pub. No.: US 2013/0156908 A1
(43) Pub. Date: Jun. 20, 2013

(54) METHOD OF TREATING VEGETABLES WITH PRESERVATIVE

(71) Applicant: SANKO CHEMICAL INSTITUTE CO., LTD., Tokyo (JP)

(72) Inventor: Isao Sakai, Tokyo (JP)

(73) Assignee: SANKO CHEMICAL INSTITUTE CO., LTD., Tokyo (JP)

(21) Appl. No.: 13/713,230

(22) Filed: Dec. 13, 2012

(30) Foreign Application Priority Data
Dec. 16, 2011 (JP) JP2011-275288
Mar. 6, 2012 (CN) CN201210057425.7

(51) Int. Cl. A23B 7/10

(52) U.S. Cl. CPC A23B 7/10
USPC 426/335

(57) ABSTRACT

After vegetables are immersed in an aqueous solution containing 0.1 to 1.0% by weight of lactic acid, so that putrefactive bacteria are removed from the surface of the vegetables. Thereafter, the vegetables are dried at low temperature thereby preventing putrefactive bacteria from breeding.

### CROSS-REFERENCE TO RELATED APPLICATIONS

This application claims priority to Japanese Patent Application No. 2011-275288 filed Dec. 16, 2011 and Chinese Patent Application No. 201210057425.7 filed Mar. 6, 2012, herein incorporated by reference in their entirety.

### BACKGROUND OF THE INVENTION

The present invention relates to a method of treating vegetables with preservative and, in particular, to a method of treating vegetables so that the vegetables may not rot even for a long time storage with reduced bacteria.

Conventionally, garlic which contains sterilizing ingredient was considered not to rot and literatures on preservative treatment for garlic were not found. General vegetables were not sterilized before distribution.

Bad smell of raw garlic is caused by SO2 produced by decomposition of allyl sulfide with alkali.

A method of making garlic odorless is described in JP6-311857A. Garlic cloves are put into a steam boiler under one atom and boiled at 120 C for about two minutes, so that disulfides which cause bad smell are vaporized and released. Thus garlic becomes odorless after the treatment, but the sterilizing ingredient is also deactivated, so that garlic is likely to rot.

Sodium hypochlorite is used as sterilizing and preservative agent. Vegetables are used after washing, so suitable sterilization against sticking bacteria is not known.

In JP6-311857A, characteristic odor of raw garlic can be removed. By heating at 120 C under 1 atom, the sterilizing ingredient is deactivated. When garlic is left in a room, bacteria in air sticks to garlic. Moisture is put from air onto overlapped cloves to make bacteria to breed.

Other methods for making garlic odorless comprise chemical decomposition of sterilizing ingredients which causes bad smell. So sterilization is deteriorated, and putrefactive bacteria in air stick and breed to make garlic rot.

A great number of putrefactive bacteria are alive and vegetables are washed after harvest. Even if the surface is dried, putrefactive bacteria still remain and breed at piled contact portions to make the vegetables to rot.

Vegetables to which sodium hypochlorite is applied are discolored by heating, and become tasteless or too salty.

### SUMMARY OF THE INVENTION

The object of the invention is to provide a method of treating vegetables with preservative wherein bacteria are removed from the surface of the vegetables to prevent stored vegetables from rotting and infecting to human.

The vegetables include root vegetables, stem vegetables, leaf vegetables, fruit vegetables, flower vegetables, potatoes, beans, mushrooms and grains.

The root vegetables include Japanese radishes, turnips, horse radishes, gingers, carrots, lotus roots and lily bulbs.

The stem vegetables include garlic, onions, long onions, bamboo shoots and asparaguses.

The leaf vegetables include Japanese mustard spinaches, cabbages, Chinese cabbages, Japanese parsleys, leeks, spinaches and lettuces.

The fruit vegetables include eggplants, tomatoes, sweet peppers, cucumbers, white gourds, peppers and zucchinis.

The flower vegetables include broccolis and cauliflowers.

The potatoes include sweet potatoes, taros and yams.

The beans include red beans, kidney beans, peas, green soybeans, broad beans, soybeans and peanuts.

The mushrooms include pine mushrooms, shiitake mushrooms, eryngi mushrooms and brown beach mushrooms.

The grains include corns.

### DETAILED DESCRIPTION OF PREFERRED EMBODIMENTS

The present invention will be described in detail as below.

### Example 1

Garlic was used as vegetable. When raw garlic produced in Akita of Japan remained after purchase, bacteria 103/g on the surface of the garlic were breeding and caused the garlic to rot.

As antiseptic process in this invention, an aqueous solution which contains 0.1% by weight of lactic acid, an aqueous solution which contains 1% by weight of lactic acid and an aqueous solution which contains 0.1% by weight of sodium bicarbonate and 0.1% by weight of lactic acid were prepared. Raw garlic cloves 5 kg were immersed in 10 kg of the three aqueous solutions respectively.

The temperature of the solutions was 25 C and the garlic was immersed for fifteen minutes. In this invention, the temperature and time of the immersion may preferably be 20 to 35 C and 10 to 30 minutes respectively.

After the immersion, the garlic cloves were taken out of each of the solutions and dehydrated with a centrifuge separator for five minutes.

The garlic cloves treated with preservative were dried through air blow in a drying chamber at 30 C until the water content became less than 60%. The room temperature may preferably be 15 to 35 C.

The preservative-treated garlic cloves after drying were stored on the shelves of a factory. Ten days later, three cloves of the garlic were removed at random and it was examined whether or not bacteria existed on the surface. The average count numbers were described in Table 1.

TABLE 1

| | | | Lactic acid 0.1% |
|---|---|---|---|
| | | | and Sodium |
| Bacteria/sample | Lactic acid 0.1% | Lactic acid 1% | bicarbonate 0.1% |
| Bacteria (cfu/g) | 3.0 | 8.0 | 3.0 |
| Coli bacilli | Not detected | Not detected | Not detected |
| (MPN/g) | | | |

As shown in Table 1, even when the lactic acid was contained at 0.1% by weight, bacteria were recognized to decrease significantly.

The medium of use was a standard agar medium for bacteria and BGLB medium for coli bacilli, and the number of living bacteria was calculated with dilution plate technique and frequency technique and described per 1 g. In Table 1, “cfu” and “MPN” are abbreviations of “colony forming unit” and “most probable number” respectively, which are the number of bacteria and coli bacilli per 1 g calculated by the foregoing technique.

Moisture content of raw garlic was ordinarily 65 to 80% by weight right after harvest, while after the preservative treatment of the present invention, the moisture content was less than 60% and the surface was dry. Thus, putrefactive bacteria in air were unlikely to stick to the garlic. Even if bacteria should stick, they will be unlikely to breed, so that garlic can be stored without rotting for a long time.

### Example 2

Five kilograms of onions, carrots, taros, kidney beans, Japanese mustard spinaches, broccolis and shiitake mushrooms respectively were immersed in 10 kg of each aqueous solution similar to the above.

The immersion was carried out at 25 C for fifteen minutes.

The temperature may range from 20 to 35 C and the immersion time may range from 10 to 20 minutes. However, with respect to Japanese mustard spinaches, kidney beans, broccolis and shiitake mushrooms, the temperature was below 30 C.

After immersion treatment, the sample was taken out of each of the solutions and dehydrated by a centrifuge separator for five minutes.

Thereafter, the preservative-treated samples were dried in a drying chamber at 30 C by blowing air until surface moisture disappeared. The room temperature may preferably be 15 to 35 C.

The preservative-treated vegetables after drying were stored on shelves of a factory, and 10 days later, were selected one by one at random. As a result of the examination as to whether or not there were bacteria on the surface, it was found that all were less than detection limit.

### Example 3

Garlic treated by odor-removing process similar to odor-removing treatment described in JP6-311857A was studied. Odorless garlic treatment to samples was carried out as below.

Water was boiled in a steam pressure pot and raw garlic was put into the pot, which was closed with a cover. It was boiled for two minutes, confirming that it becomes 120 C at 1 atom. The garlic was taken out of the steam pressure pot and dried with low-temperature air blowing below 5 C. By boiling the garlic with steam, there was neither smell nor hot taste when the garlic was eaten.

In the conventional odorless garlic, the ingredient in the garlic was decomposed and bacteria-killing ability was decreased. When the garlic is stored, a lot of putrefactive bacteria will stick. When moisture and temperature meet the conditions suitable for bacteria breeding, putrefactive bacteria bred on the surface of the garlic, so that the garlic rotted inside.

The conventional preservative-treated garlic was taken out by three cloves at random. The average count number on the surface is described in Table 2.

TABLE 2

| | | Lactic acid 1% + |
|---|---|---|
| | Lactic acid 0.1% + | sodium |
| Bacteria/sample | sodium bicarbonate 1% | bicarbonate .1% |
| Bacteria (cfu/g) | 3.0 | 2.5 |
| Coli bacilli | Not detected | Not detected |
| (MPN/g) | | |

As shown in Table 2, even when the lactic acid is contained at 0.1% by weight, the number of bacteria reduced significantly. Thus, even if bacteria in air stick to garlic after the preservative treatment, it will be very difficult for the bacteria to breed thereby preventing rotting for a long-time storage. The higher the lactic acid concentration becomes, the more effectively the garlic is treated with preservative.

### Example 4

Prior to immersion in the foregoing lactic acid aqueous solution, one or combinations were selected from the group consisting of acetic acid, malic acid, tartaric acid, citric acid and phytic acid, and prepared as treating solution. Raw garlic cloves were immersed in the solutions. After the treatment, the garlic was immersed in the lactic acid aqueous solution.

In Example 4, 25 g of citric acid and 25 g of acetic acid were mixed in 10 kg of water. Five kilograms of raw garlic cloves were immersed therein for fifteen minutes. After showering, water was removed with a dehydrator. The garlic thus treated was immersed in the lactic acid solution and treated with preservative similar to the above.

The preservative-treated garlic cloves were left in a room for seven days. Three cloves were taken out at random, and the average count number of putrefactive bacteria on the surface was shown in Table 3.

TABLE 3

| | (Citric acid + acetic | (Citric acid + Acetic |
|---|---|---|
| | acid) 0.5% | acid) 0.5% |
| Bacteria/sample | Lactic acid 0.1% | Lactic acid 1% |
| Bacteria (cfu/g) | 4.0 | 20 |
| Colon bacilli | Not detected | Not detected |

As shown in Table 3, even when lactic acid was contained at 0.1% by weight, the garlic was able to be sterilized and colon bacilli were not detected.

The garlic was eaten without hot taste, acidity or odor. Organic acids are permeable into garlic to promote reaction of the ingredients and make lactic acid more permeable to promote reaction of ingredients and precipitation into water, thereby decomposing odor ingredient.

The treated garlic cloves were eaten by three persons whose breathes are smelled by other three persons. It was determined that there was no characteristic odor of garlic, so that deodorizing effect was confirmed.

The immersion time of garlic in the preservative-treated solution is variable up to 90 C depending on bath temperature, size of the garlic and the amount of the garlic.

Organic acid added to the aqueous solution is one or combinations selected from the group consisting of acetic acid, malic acid, tartaric acid, citric acid and phytic acid.

The organic acid may be used at 0.2 to 5% by weight with respect to the lactic acid solution.

In the garlic treated with organic acid, sterilizing ingredient in the garlic was deactivated by the organic acid thereby making putrefactive bacteria to breed. But in the preservative treatment, the garlic was immersed in the lactic acid, so that putrefactive bacteria did not stick. Putrefactive bacteria were restrained from breeding even if the putrefactive bacteria stick. Even in a long time storage, the garlic was unlikely to rot. The organic acid stabilized pH as buffering agent.

Products in which the garlic cloves are sliced and ground are unlikely to rot. The garlic cloves which were treated with preservative were dried and powdered. Bacteria breeding on the garlic powder was not recognized in analysis test of bacteria.

After preservative treatment, the surface was dried and stored to enable garlic to be stored for a long time and to be distributed without cooling. For a short time, putrefactive bacteria significantly decrease, so that infection unlikely occurs after cooking.

What is claimed is:

1. A method of treating vegetables with preservative, the method comprising:
immersing the vegetables in an aqueous solution containing 0.1 to 1.0% by weight of lactic acid; and
drying the vegetables at low temperature to prevent putrefactive bacteria from breeding.

2. The method of claim 1 wherein the lactic acid aqueous solution has temperature of 20 to 35 C, the vegetables being dried by air blowing at room temperature of 15 to 35 C after immersion for 10 to 20 minutes.

3. The method of claim 1 wherein sodium biocarbonate is contained at 0.1 to 1% by weight in the lactic acid aqueous solution.

4. The method of claim 1 wherein before the vegetables are immersed in the lactic acid aqueous solution, the vegetables are immersed in an aqueous solution containing 0.2 to 1% by weight of one or combination selected from the group consisting of acetic acid, malic acid, tartaric acid, citric acid and phytic acid.

5. The method of claim 1 wherein the vegetables are garlic.
